(19) United States
(12) Patent Application Publication
(10) Pub. No.: US 2018/0280122 A1
(43) Pub. Date: Oct. 4, 2018

(54) METHOD AND SYSTEM FOR MEDICAL TREATMENT AND REHABILITATION OF JAWS

(71) Applicants: Mishel VESHLER, Natzeret Elit (IL); Benzi Aharoni, Natzeret Elit (IL)

(72) Inventors: Mishel VESHLER, Natzeret Elit (IL); Benzi Aharoni, Natzeret Elit (IL)

(21) Appl. No.: 14/564,118

(22) Filed: Dec. 9, 2014

(51) Int. Cl. A61C 8/00

(52) U.S. Cl. CPC A61C 8/0077; A61C 13/0003

(57) ABSTRACT

The present invention innovates within the method and system which enable a dentist to treat and rehabilitate a patients jaw, whereas the method is enabled by a first part which includes a bridge-rod, whereas to this rod part coordinators are threaded which include in their configuration a clamp which enables the sliding of the coordinators upon the rod to different locations on the rod, and whereas the second part which is the coordinator component includes a clasping method such as a screw which could screw onto a part external to the coordinator, and whereas a screw such as the coordinator is screwed and connected to the implant, and whereas a number of coordinators are connected to a number of implants, the coordinators settle in coordination upon the part of the rod, the first part, and whereas the dentures are supplied with a connecting mechanism which are connected to the dentures in their inner part and are coordinated to clasp the dentures upon the rod, the first part.

### BACKGROUND OF THE INVENTION

The present invention is in the field of treatment and rehabilitation of peoples jaws, more specifically the present invention is a method and system that enables the implant of false teeth in the mouth of the patient, in a way that make possible for a dentist, to enable the systems implant in the patients jaw, without the need to send sizes or receive contraptions for holding the false teeth from dental technicians laboratories, thus saving on the time and cost of the treatment.

It is known to one skilled in the art, in the dental field, that the human teeth system and jaw are systems that need treatment, upkeep and rehabilitation throughout the human life. The vast majority of peoples' teeth don't withstand in proper order throughout the entire human life, and treatment, upkeep and rehabilitation for teeth and jaws are inevitable in the existing reality.

In the field of treatment and rehabilitation one of the existing solutions is installing transplants in the patients jaw and connecting dentures, false teeth, on the implants.

With the methods and techniques available in the field prior to this invention, the method requires earlier planning between the dentist and the technicians labs—in order to fit and receive from the teeth technician's lab a bridge that includes a clasping mechanism which is fitted to connect to the implants inserted in the patients mouth, wherein, following that fitting of the dentures takes place which include a clasping mechanism that is inserted into their inner part and is fitted to clasp and connect to the bridge apparatus, and to this device.

The dentist using the earlier craftsmanship takes measurements between implant and implant, and measurements as to the depth and angle of each implant in relation to the specific jaw. According to these measurements, this information is forwarded to a dental technicians lab, and the dental technician makes a fixed and non-dynamic mold of such connecting bridge-rod structure, and upon it indifferent locations are the connecting mechanisms which screw on to the implants. The dentist receives such kit, installs it in the patient's mouth, and often the kit is returned to the dental technician due to inaccuracies requiring changes.

The system and method of the earlier craftsmanship, requires the transportation of the work on the infrastructure to which the dentures connect between both factors, the dentist and the technician lab. In addition, the fact that the work of the dental technician usually takes place without the patient being nearby and not from first hand, and, the fact that the existing system is cumbersome and as a result of this the costs are high in cases such as these where the payment comes out of the patients pocket.

There is a need for improvement and innovation in the existing method and system of the care and installment of false teeth and their infrastructure upon which they are built, in order to lower costs for the patients, since it is common today for people to reach advance ages without taking care of their false and real teeth at all due to the cost that is above their financial abilities.

The current invention enables a method and system that makes the need for transporting the work of preparing the infrastructure for clasping of the false teeth to an external dental lab obsolete, and enables care within the method and system while shortening the time cost through the duration of the treatment and the rehabilitation with only the help of the dentist, whereas only the dentures themselves are received from the dental lab.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

The current invention revolutionizes in system and in method, and makes it possible for the dentist to perform the care of the system and the structure needed within the patient's mouth, in a way that enabling to connect a set of false teeth to a patient's mouth. Wherein, such method and systems components are as follows:
a. The dentist uses the first part of the current invention which includes a bridge-rod which designates to connect between implants in the patient's mouth—and betweens a set of false teeth that are supplied to the dentist. Wherein, such bridge-rod is in the formation which allows the insertion of a second component which is the supplied coordinator. Wherein, such coordinator has a trait which allows the movement of the coordinator on the length of the bridge-rod until the location required by the dentist, and wherein;
b. The coordinator, the second part of the current invention, includes a certain peripheral formation which enables the insertion and interweaving of the coordinator upon the systems first part, the bridge-rod, in a way whereas the a sliding motion upon the rod is enabled to the location required to the dentists opinion, and wherein;
c. A component for the part of the current invention, the coordinator, includes in addition to the coordinating component a component which is fitted for inserting clasping and connecting mechanisms which enable clasping and connecting the coordinator to external agents such as screws, and wherein;
d. The dentist slides the coordinator upon the bridge-rod to the location of the coordinator above the placement of one of the implants implanted in the patients jaw and mouth, and in this location the connection and fixation of the coordinator is performed using connecting means such as a screw screwed to one of the implants implanted in the patients mouth, in a way which the fixation of the coordinator and the rod in a certain connecting location above the location of a certain implant in the patients mouth takes place, and wherein;
e. Clasping and connecting of more than one coordinator takes place, between the coordinators and the bridge-rod in more than one location, above different locations in coordination with more than one implant, the fixation of the bridge-rod between two or more connecting points takes place, and the method and system of the current invention is enabled in a way that the placement and installment of the false teeth is ready and it becomes possible to assemble the false teeth upon the rod, by connecting the coordinators located in the inner part of the false teeth and fitted for clasping upon the bridge-rod, and wherein;
f. The coordinator in the current method and system are supplied in a number of sizes, by means of supplying the dentist coordinators of various sizes, and whereas the various sizes come into play with the coordinator component found under the area of the bridge-rod of the set implanted in the lower teeth, or the coordinator component implanted above the bridge-rod of the set implanted in the upper teeth, whereas different sizes which are enabled in these parts enable the dentist to choose from a number of coordinators the coordinator which fits the specific implant, for example for an implant located deeper in the mouth than a different implant located near it in the lower teeth system, a taller coordinator will be chosen which will enable coordination and connection between both implants, the bridge-rod and the coordinator.
g. The connecters placed in the inner part of the false teeth, which include a circular configuration only with an opening at the bottom which could be connected by means of pressure to the bridge-rod, are enabled in the current system by the structural configuration which includes within its upper part a platform whose upper part isn't circular, rather flat, in a way which enables the coordinator to connect and clasp the false teeth fitted for placing with the current method and system more effectively.

### BRIEF DESCRIPTION OF THE DRAWINGS

The added drawings in this patent application come in order to provide more visual understandings about the invention and are integral part of the request and the invention. The drawings describe different functions of the invention and, added to all the mentioned above, serve the purpose of explaining the principles and ways of operation and not, by any means, suppose to limit the invention solely to them.

FIG. 1, is a flowchart which demonstrates an example included in the present invention which demonstrates the system and the method of the current invention.

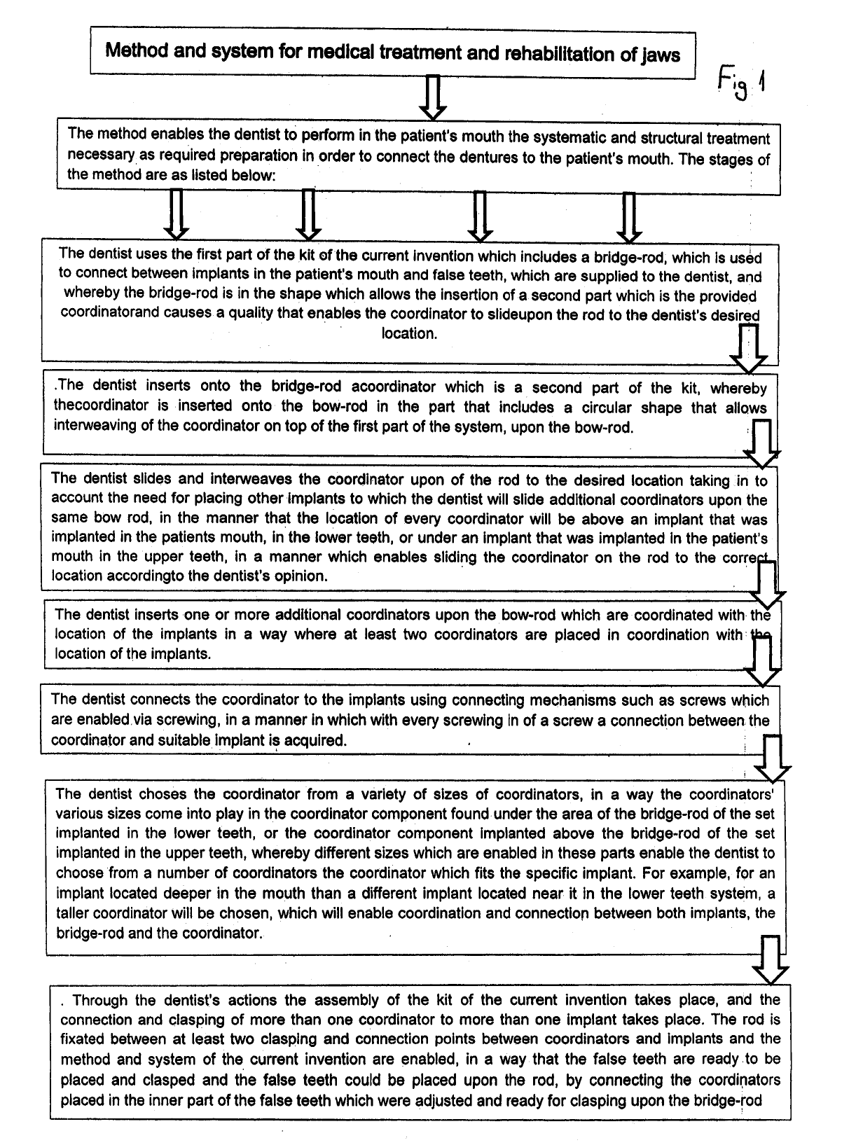

FIG. 2 is one schematic implementation of description which demonstrates an example included in the coming into effect of the current invention which demonstrates the components and placement of the kit's parts which enable the system in the current invention.

FIG. 3 is another schematic perspective view of implementation which demonstrates an example included in the coming into effect of the current invention which demonstrates the components and placement of the kit's parts when they are connected as to the system in the current invention.

### DESCRIPTION OF THE PREFERRED EMBODIMENTS

A description of the sketches in this appendix and the sketches to which we will refer are included in this patent application for the purpose of further understanding of this invention and are included and constitute as part of this request. The description of the sketches displays a more detailed explanation of different aspects of the invention and together with the diagrams and the rest of the patent request documents are serving the purpose of explaining the principals and the manner of carrying out the invention, and all this in the manner of example only, and not in any way for the purpose of limiting to these descriptions and only them.
1. Diagram 1 is a flow chart that describes an example that is included in the current invention which displays the method of the current invention whereas the method enables the dentist to perform in the patients mouth the systematical and structural treatment necessary as required preparation in order to connect the dentures to the patients mouth, wherein the stages of the method are as listed below:
   The dentist uses the first part of the kit of the current invention which includes a bridge-rod, which is used to connect between implants in the patients mouth, the implants, and false teeth, which are supplied to the dentist, wherein, the bridge-rod is in the shape which allows the insertion of a second part, which is the provided coordinator—which has a quality that enables the coordinator to slide upon the bridge-rod to the dentists desired location;
   Wherein, the dentist inserts onto the bridge-rod a coordinator which is a second part of the kit, whereas the coordinator is inserted onto the bow-rod in the part that includes a circular shape that allows interweaving of the coordinator on top of the first part of the system, upon the bow-rod; Wherein, the dentist slides and interweaves the coordinator upon of the rod to the desired location taking in to account the need for placing other implants to which the dentist will slide additional coordinators upon the same bow rod, in the manner that the location of every coordinator will be above an implant that was implanted in the patients mouth, in the lower teeth, or under an implant that was implanted in the patients mouth in the upper teeth, in a manner which enables sliding the coordinator on the bridge-rod to the correct location according to the dentists opinion;
   Wherein, the dentist inserts one or more additional coordinators upon the bow-rod which are coordinated with the location of the implants in a way where at least two coordinators are placed in coordination with the location of the implants;
   Wherein, the dentist connects the coordinators to the implants using connecting mechanisms such as screws which are enabled via screwing, in a manner in which with every screwing of a screw a connection between the coordinator and suitable implant is acquired. And whereas, through the dentists actions the assembly of the kit of the current invention takes place, and the connection and clasping of more than one coordinator to more than one implant takes place, and the rod is fixated between at least two clasping and connection points between coordinators and implants and the method and system of the current invention are enabled;
   Wherein, in that way that the false teeth are ready to be placed and clasped and the false teeth could be placed upon the rod, by connecting the coordinators placed in the inner part of the false teeth which were adjusted and ready for clasping upon the bridge-rod;
   Wherein, a method as mentioned whereas the dentist choses the coordinator from a variety of sizes of coordinators, in a way the coordinators' various sizes and angles come into play in the coordinator component found under the area of the bridge-rod of the set implanted in the lower teeth, or the coordinator component implanted above the bridge-rod of the set implanted in the upper teeth. Whereas different sizes which are enabled in these parts enable the dentist to choose from a number of coordinators the coordinator which fits the specific implant, for example for an implant located deeper in the mouth than a different implant located near it in the lower teeth system, a taller coordinator will be chosen which will enable coordination and connection between both implants, the bridge-rod and the coordinator.

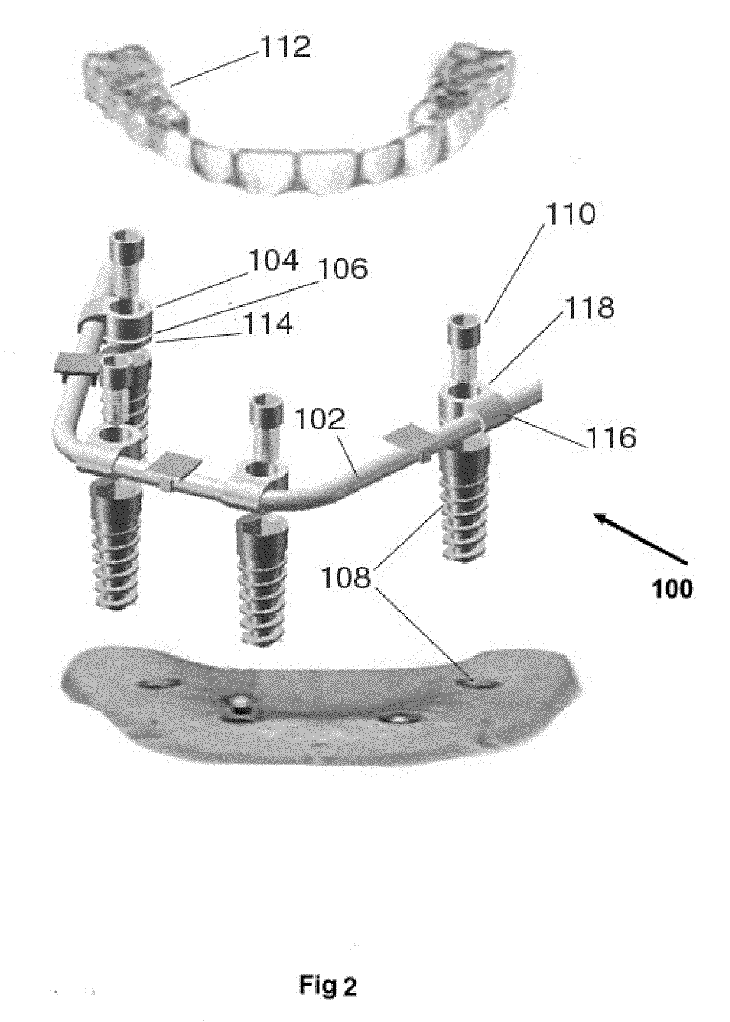

FIG. 2 is a schematic depiction describing an example 100 which includes the components of the current invention, which demonstrates the components and placement of the parts of the kit which enable the system of the current invention, wherein the components include a first part which is a designated bridge-rod 102 designated for clasping false teeth 112, a second part, which is a coordinator 104 which can be inserted and slid over the length of the rod 102 and include different sizes of coordinating as a solution to depths and the varying slanting angles of one implant 108 verses other implants. Whereas this coordinating part 104 includes a method for clasping 106 which enables the insertion of a screwing mechanism such as a screw 110 which is enables connection between the coordinator 104 and the implant 108.

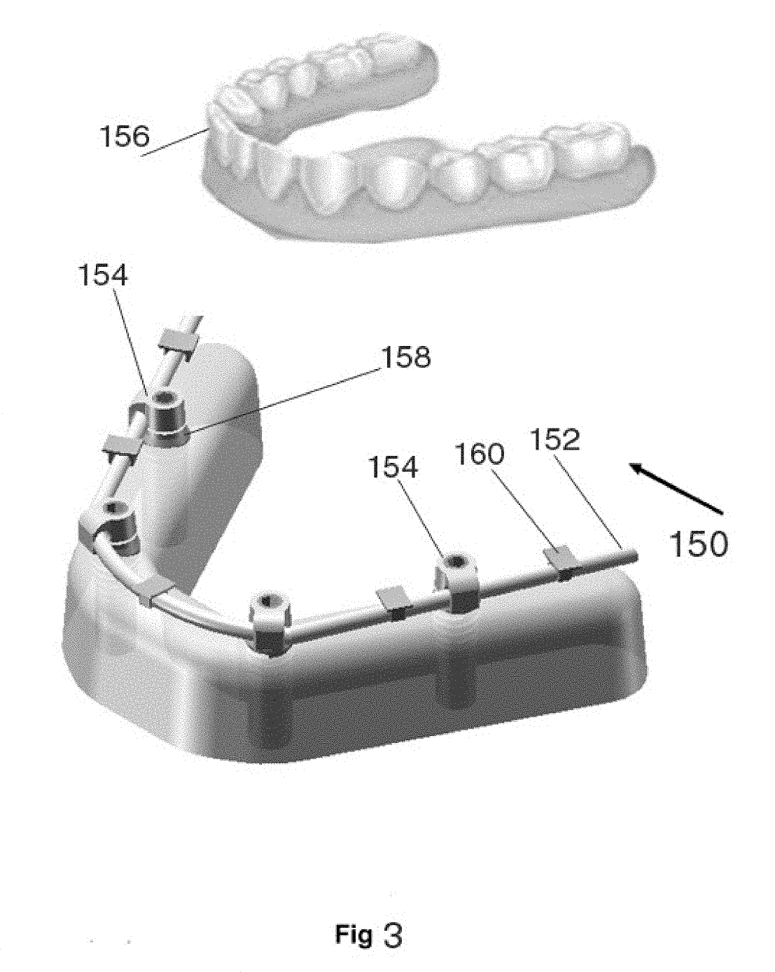

FIG. 3 is a schematic depiction describing example 150 which includes the component of the current invention which demonstrates the components and placement when they are attached, as to the system of the current invention. Whereas the components include a first component which is a designated bridge-rod 152 designated for clasping false teeth 156, a second component, which is a coordinator 154 which can be inserted 152 and slid over the length of the rod 152, and includes different sizes of coordinating as a solution to depths and the varying slanting angles of one coordinator 158 verses other coordinators. Whereas this coordinating part includes some clasping means, enables the insertion of a connecting mechanism such as a screw which could connect the coordinator 154 and the implant 158. Wherein, at the time of clasping the suitable coordinators, the clasping and fixation of the coordinators 154 with the implants 158 and with the bridge-rod 152 is enabled in the optimal medical manner, in a way which enables the installation of the false teeth 156 on the rod 152 using another type of connectors 160. Wherein, the bridge-rod is optionally flexible to some extent, to enable the dentist to bend the bridge-rod to the shape of each particular jaw and respectively to implements are to be in the patient mouth. Wherein, the bridge-rod and coordinator are at list partially made from materials that enables the treatment of the system in the patient jaws, and the flexibly, for example: Titanium; Chromium and cobalt; Chromium-nickel; Composites molding; Metals with memory; Metals without memory; Zirconium; And Polymers.

1. The present invention introduces a method designated to enable and perform two treatments that performed in the prior art by at list two persons and in two locations and not at the same time, by dentist and by technician, by one person—by professional dentist in one time and in the same place;
Wherein, such method, allows the dentist to perform in the same time, and in one treatment, in the patients mouth both—the implants, and the bridge-rod connecting to the implants and designated to hold some set of “false teeth” to the patients mouth;
Wherein the stages in such method of technique are as follows:
a. The dentist uses the first part of the current invention “kit” which includes “a semi-flexible bridge-rod” which is connected from one side to the implants in a patients mouth, and is designated to hold a set of false teeth supplied to the dentist;
Wherein, the pole (the bridge-rod) has a configuration enables an insertion of another part, which is a supplied adaptor, and has a quality which enables the moving of the adaptor to a required location on the “bridge-rod” that parallel to some implant location, wherein;
b. The dentist inserts unto the “bridge-rod” a adaptor which is the mentioned second part of the “kit”, wherein, the adaptor is inserted to the bow-rod by the “circular ring configuration” of the adaptor, which enables the insertion and interweaving of the adaptor upon the kits first part, on the bridge-rod, wherein;
c. The dentist slides and interweaves the adaptor on the bridge-rod to the desired location while taking into account the need of placing additional implants onto which the dentist will slide additional adaptors on the same bridge-rod, in a way that the placement of each adaptor respectively to implant that it is connected to, and to part of the denture, the “false teeth” that he holds; wherein, each adaptor enabled by sliding on the bridge-rod until reaching the place desired accordingly to each implement it has to be connected to, by the dentist, wherein;
d. The dentist inserts one or more additional adaptors on the bridge-rod that are adjusted in their place according to the location of the implants in a way that at least two adaptors needed in order to enable connecting the bridge-rod to the implements and enable connection of the “false teeth” to the bridge-rod by connecting them to the adaptors, wherein;
e. The dentist connects the adaptors to the implants by means of a connecting mechanism, such as screws, which are enabled by screwing, in a way that clasps with every screwing of a screw are connection between some adaptor to some fitting implant, wherein;
f. The dentists fitting the “kit”, to each patient, fitting “the semi-flexible bridge-rod” and at list two adaptors respectively to more than one implant, wherein, the fixation and Installation of at least two grasping and connecting points of adaptors to implants are enabled, wherein the method and system of the current invention are enabled in a way that the preparation for placing and clasping the false teeth is ready, and it is possible to assemble the false teeth upon the bridge-rod, by connecting the adaptors which are placed in the inner part of the false teeth and are adjusted to clasp the bridge-rod, wherein;
g. The method described wherein the semi-flexible bridge-rod is optionally flexible to some extent, to enable the dentist to bend the bridge-rod to the shape of each particular jaw and implements that are to be in the patient mouth.

2. The method as described in claim 1, wherein the dentist chooses a adaptor from a number of different size of adaptors, wherein, different sizes of adaptors made possible and enable the dentist to choose, the one adaptor that fits to the specific type of implants and patient jaws, for example, enabling placing an implant deeper than another implant if its location is lower than another implements in the jaw, wherein, in such environments a adaptor with a higher coordinating piece will be chosen allowing adaptors to connect at least two implants to the adaptors, and such adaptors connected to the bridge rod.

3. The method which is described in claim 1, or in claim 2, wherein at the time of connecting the adaptors to the implants as planned by the dentist the system enables a connection between the implants and the semi-flexible bridge-rod in an optimal medical way, and in a way that enables installing of the false teeth on the semi-flexible bridge-rod effectively, wherein;

4. The present invention introduces a system designated to enable and perform two treatments that performed in the prior art by at list two persons and in two locations and not at the same time, by dentist and by technician, by one person—by professional dentist in one time and in the same place;
Wherein, such system, allows the dentist to perform in the same time, and in one treatment, in the patients mouth both—the implants, and the bridge-rod connecting to the implants and designated to hold some set of “false teeth” to the patients mouth;
Wherein such system of technique is as follows:
a. The dentist uses the first part of the current invention “kit” which includes “a semi-flexible bridge-rod” which is connected from one side to the implants in a patients mouth, and is designated to hold a set of false teeth supplied to the dentist;
Wherein, the pole (the bridge-rod) has a configuration enables an insertion of another part, which is a supplied adaptor, and has a quality which enables the moving of the adaptor to a required location on the “bridge-rod” that parallel to some implant location, wherein;
b. The dentist inserts unto the “bridge-rod” a adaptor which is the mentioned second part of the “kit”, wherein, the adaptor is inserted to the bow-rod by the “circular ring configuration” of the adaptor, which enables the insertion and interweaving of the adaptor upon the kits first part, on the bridge-rod, wherein;
c. The dentist slides and interweaves the adaptor on the bridge-rod to the desired location while taking into account the need of placing additional implants onto which the dentist will slide additional adaptors on the same bridge-rod, in a way that the placement of each adaptor respectively to implant that it is connected to, and to part of the denture, the “false teeth” that he holds; wherein, each adaptor enabled by sliding on the bridge-rod until reaching the place desired accordingly to each implement it has to be connected to, by the dentist, wherein;
d. The dentist inserts one or more additional adaptors on the bridge-rod that are adjusted in their place according to the location of the implants in a way that at least two adaptors needed in order to enable connecting the bridge-rod to the implements and enable connection of the “false teeth” to the bridge-rod by connecting them to the adaptors, wherein;
e. The dentist connects the adaptors to the implants by means of a connecting mechanism, such as screws, which are enabled by screwing, in a way that clasps with every screwing of a screw are connection between some adaptor to some fitting implant, wherein;
f. The dentists fitting the “kit”, to each patient, fitting “the semi-flexible bridge-rod” and at list two adaptors respectively to more than one implant, wherein, the fixation and Installation of at least two grasping and connecting points of adaptors to implants are enabled, wherein the method and system of the current invention are enabled in a way that the preparation for placing and clasping the false teeth is ready, and it is possible to assemble the false teeth upon the bridge-rod, by connecting the adaptors which are placed in the inner part of the false teeth and are adjusted to clasp the bridge-rod, wherein;
g. The system described wherein the semi-flexible bridge-rod is optionally flexible to some extent, to enable the dentist to bend the bridge-rod to the shape of each particular jaw and implements that are to be in the patient mouth.

5. The system as described in claim 4, wherein the dentist chooses a adaptor from a number of different size of adaptors, wherein, different sizes of adaptors made possible and enable the dentist to choose, the one adaptor that fits to the specific type of implants and patient jaws, for example, enabling placing an implant deeper than another implant if its location is lower than another implements in the jaw, wherein, in such environments a adaptor with a higher coordinating piece will be chosen allowing adaptors to connect at least two implants to the adaptors, and such adaptors connected to the bridge rod.

6. The system which is described in claim 5, or in claim 6, wherein at the time of connecting the adaptors to the implants as planned by the dentist the system enables a connection between the implants and the semi-flexible bridge-rod in an optimal medical way, and in a way that enables installing of the false teeth on the semi-flexible bridge-rod effectively.
